(19) United States
(12) Patent Application Publication
(10) Pub. No.: US 2009/0174169 A1
(43) Pub. Date: Jul. 9, 2009

(54) HUMAN-POWERED MACHINE OR VEHICLE

(76) Inventors: Aleksey POLYAKOV, Essen (DE); Anatoly Polyakov, Essen (DE)

Correspondence Address: K.F. ROSS P.C., 5683 RIVERDALE AVENUE, SUITE 203 BOX 900, BRONX, NY, 10471-0900, US

(21) Appl. No.: 12/348,334

(22) Filed: Jan. 5, 2009

(30) Foreign Application Priority Data
Jan. 4, 2008 (DE) 102008003191.7

(51) Int. Cl. B62M 1/02

(52) U.S. Cl. 280/259; 280/263

(57) ABSTRACT

A muscle-powered machine has a frame, a drive wheel rotatably mounted on the frame and rotatable in a plane defining a normal straight-ahead travel direction, and a drive pedal engageable with a foot of a user of the machine and having one end pivoted on the frame forward of the user's foot. The pedal is pivotal through an acute angle on the frame between an upper position and a lower position with the pedal extending at an angle of 90° ±10° to a lower leg of the foot on the pedal. A quotient of the maximum vertical travel of the pedal measured perpendicular to the pedal in its lower end position and the sine of the angle is greater than the length of the pedal measured radially of its pivot. A drive connected between the pedal and the drive wheel converts oscillation of the pedal between its end positions into rotation of the wheel.

### FIELD OF THE INVENTION

The present invention relates to a human-powered system. More particularly this invention concerns a machine or vehicle that is operated by human muscle power.

### BACKGROUND OF THE INVENTION

The invention relates to a muscle-powered machine or vehicle comprising a drive mechanism and a frame as a component of the vehicle or of the machine and at least one drive pedal or lever pivoted on the frame for transmitting the muscle power to at least one component to be driven of the vehicle or of the machine. The drive pedal has a support surface for the user's foot and can move in a work cycle under the effect of the muscle power between two end positions through an acute angle whose apex is located in front of the user's foot. One end position is reached as a result of the unloading of the drive pedal after a work cycle and the other end position is reached with the user's leg extended at the end of the work cycle. In all of positions of the drive pedal, the support surface forms a right angle ±10° with the lower part of the leg acting on the support surface.

A corresponding muscle-powered vehicle can be, for example, a two-axle vehicle driven by the drive mechanism. It can also be a watercraft that is operated by a pedal drive, or a stationary machines such as are for example used for exercise and are operated in a stationary manner. These latter machines have a pedal drive that is actuated by a person for the purpose of physical fitness.

In particular the invention relates to a scooter driven by the muscle power of the user, which scooter can be used as a means of transport, sports equipment or a toy for children.

The most important features of the non-motorized scooters with a drive mechanism include its compactness and the mechanical power that can be converted in them. In the case of scooters, whose drive mechanism makes it possible to convert the weight of the user into the propelling power, the convertible mechanical power can reach the level of the maximum power developed by a person on a sustained basis. Usually these scooters have one or two drive pedals that can be actuated by the user during a ride.

Achieving the largest possible convertible power in scooters of this type is inconsistent with their compactness and driving stability. The reason for this is on the one hand that the drive pedals are often embodied in a pivoting manner for anatomical reasons. In order to achieve a sufficiently large vertical travel of the drive pedals, which determines the power, it is necessary for the maximum tilt angle thereof and their length to be correspondingly large. In turn the tilt angle is limited for anatomical as well as for physical/technical reasons and can be no more than about 25°. The length of the drive pedals determines the total length of the scooter, and enlarging it means losing compactness.

On the other hand, the components of the drive mechanism must be as small and light for maximum compactness. They are therefore mechanically greatly stressed. In order to increase the torque transmitted by the drive mechanism and (like the vertical travel of the drive pedal) determining the power, without having a negative effect on the compactness of the scooter, a corresponding design of the drive mechanism is necessary.

The reduction of the driving stability with increasing power depends, among other things, on the effect of a relatively large tilting moment in the case of the drive pedals that have a lateral offset with respect to the center longitudinal axis of the scooter. The driving stability is impaired anyway by the smaller wheels specific for a compact scooter.

Interaction of the above-referenced factors generally leads to the reduction of the riding comfort with a compact scooter compared to a larger scooter.

### OBJECTS OF THE INVENTION

It is therefore an object of the present invention to provide an improved human-powered machine or vehicle.

Another object is the provision of such an improved human-powered machine or vehicle that overcomes the above-given disadvantages, in particular that increases the power that can be converted in the vehicle or in the machine without impairing its compactness, stability and the actuation comfort, in particular also the riding stability and riding comfort.

### SUMMARY OF THE INVENTION

A muscle-powered machine has according to the invention a frame, a drive wheel rotatably mounted on the frame and rotatable in a plane defining a normal straight-ahead travel direction, and a drive pedal engageable with a foot of a user of the machine and having one end pivoted on the frame forward of the user's foot. The pedal is pivotal through an acute angle on the frame between an upper position and a lower position with the pedal extending at an angle of 90° ±10° to a lower leg of the foot on the pedal. A quotient of the maximum vertical travel of the pedal measured perpendicular to the pedal in its lower end position and the sine of the angle is greater than the length of the pedal measured radially of its pivot. A drive connected between the pedal and the drive wheel for converts oscillation of the pedal between its end positions into rotation of the wheel.

According to the invention the acute angle is about 25°.

One advantage of this solution lies in that at an anatomically correct tilt angle for example to the current plane of the road surface between about 0° in the lower end position and a maximum of 25° in the upper end position, the drive pedal has a greater vertical travel than with the known embodiments, so that the proportion of the length of the vehicle or of the machine used by the drive pedal can be minimal. This makes it possible for the full power that can be developed by the user to be converted without the length of the vehicle or of the machine thereby having to be increased.

It is preferably that the drive pedal is connected to the frame via at least two links spaced apart from one another in the longitudinal direction of the frame, the lengths of which are different. Preferably the front link closer to the apex of the angle is shorter than the rear link spaced farther from the apex.

Furthermore, it is preferred that the vehicle is a scooter and the frame is installed on the wheels or between the wheels of the scooter.

The advantage of the invention lies in the simplicity of the corresponding embodiment of the vehicle, of the machine, in particular of the scooter. With the different lengths of the links it is possible for the acute angle to be greater in the upper end position of the drive pedal than in the lower end position. Through the selection of the lengths of the links and the spatial arrangement of their pivots, the necessary value of a can be achieved with a large vertical travel.

With a vehicle or a machine according to the invention there is a drive pedal and a locking device that has at least one driving and one driven shoe that can converge and move away from one another, an action that determines the engaged or disengaged status of the locking device and thus the power transmission and momentum transmission through the latter. The drive shoe is kinematically connected to the drive pedal such that the spacing between the shoes of the locking device is not dependant on the muscle power acting on the drive pedal in the end positions of the drive pedal, preferably the locking device has at least one spring that acts on the drive shoe of the locking device in the locking device exclusively in the work cycle of the drive pedal.

The advantage of this embodiment lies in the possibility of increasing the power that can be converted in the scooter by increasing the efficiency of the drive mechanism. This increase is achieved by removing the necessity of providing the drive mechanism with a special brake. In the known embodiment of DE 103 12 878, this brake is used to render possible switchover of the locking device with the change of the sign of the force transmitted by the drive pedal to the locking device. Furthermore, with the proposed solution the construction of the drive mechanism is simplified.

It is preferably provided thereby that the driven shoe is embodied in the form of at least one hollow cylinder having a rim that forms two support surfaces, and the drive shoe is divided and can contact the support surfaces of the driven shoe via its support surfaces upon actuation of the drive pedal. The kinematic connections of the drive pedal with the drive shoe can move together the shoes having the support surfaces under the action of the driving force thereby gripping the rim between these support surfaces on actuation of the drive pedal.

This proposed embodiment is advantageous because the normal force in the contact zones between the drive shoe and the driven shoe of the locking device can be sufficiently high in one operation with a still acceptable Hertzian pressure to render possible transmission of the large drive torque through the locking device. The convertible power is thus increased with minimal size and the weight of the drive mechanism.

Preferably it is furthermore provided that the kinematic connection of the drive pedal to the drive shoe is carried out via at least two lever arms, the lengths of which are in a ratio to one another in which a non-positive torque transmission is possible through the locking device without sliding between the driving and the driven shoe.

The proposed solution complies with the condition of a safe non-positive torque transmission through the locking device and is therefore also advantageous.

Furthermore, it is preferably provided that the support surfaces of the drive shoes are circularly arcuate and have radii of curvature identical to the radii of the respective surfaces of the rim of the driven shoe and the centers of curvature thereof lie on the rotation axis of the driven shoe during the torque transmission through the locking device.

The loading of the shoes of the locking device is hereby the lowest with other determined parameters.

With a vehicle with a chain drive or synchronous belt drive between at least two shafts of the drive mechanism it is preferably that the chain or the toothed belt on at least one of the sprocket wheels transmitting the propelling power or one of the pulleys transmitting the propelling power with the other side bears against at least one other sprocket wheel transmitting the propelling power or at least one other pulley transmitting the propelling power. In this manner the drive wheel can rotate opposite to the input wheel operated by the shoes on the lever.

The advantage of this vehicle lies in the possibility of arranging the locking device in the front part of the scooter and thus realizing a simple kinematic connection that is effective in terms of the convertible power and the compactness of the scooter between the locking device and the drive pedal. The solution according to the invention renders possible the change of the direction of rotation of the shafts of the drive mechanism necessary thereby with low expenditure.

With the actuation of the drive pedal with a support surface laterally offset with respect to the center longitudinal axis of the vehicle or scooter, a tilting moment is produced that, without special countermeasures, can lead to tipping of the vehicle or scooter from an upright plane. In order to produce an improvement here, it is proposed that the arrangement of the springs with respect to the axis of the guide pivot of the wheel renders possible a non-positive value of the second dissipation of the torque according to the steering-lock angle of the wheel at least in the range ±45°.

The riding stability of the vehicle or scooter is herewith increased. The proposed embodiment prevents the steerable wheel from deviating from the original position due to the action of the steering during the actuation of the drive pedal, and thus causing an undesirable change of the direction of travel. It should also be prevented thereby that the excessive increase of the torque transmitted by the steering with the enlargement of the steering-lock angle of the wheel makes it difficult to steer the scooter or the vehicle.

With a vehicle or scooter with at least one drive pedal that has a support surface for an actuation by the user, which is laterally offset with respect to the center longitudinal axis of the vehicle or the machines, it is proposed that the frame of the vehicle or of the machine forms at least one additional contact or support surface for the user's body via one or more components mechanically connected to the frame, via which contact surface the tilting moment developing upon actuation of the drive pedal can be transmitted by the frame to the user's body. The negative consequences of the tilting moment are thus largely avoided.

This solution makes it possible for the tilting moment to be guided through one or more additional components from the frame of the scooter to the body of the user, so that the body can serve as momentum support. It is advantageous to arrange the contact surface between the component and the body of the user as far as possible from the frame, so that the lever arm for transmitting the tilting moment is large and the corresponding force is relatively small.

It is preferably provided that the additional contact surface is formed by one or more components attached to the steering column or to another column pivoted on the steering column and/or to the frame of the vehicle or machine, the form of which components renders possible support for the user.

The components can be, for example, a link shaped in a certain manner or a yoke shaped in a certain form. The advantage of this solution is an improvement of the handling properties of the vehicle, in particular scooter, and a relief of the arms and the wrists of the user while riding.

Furthermore, the components forming the additional contact surface can assume at least two positions stabilized by a spring suspension, wherein in one of these the tilting moment can be counteracted during the actuation of the drive pedal, and in the other position the obstruction of the user by these components on leaving the vehicle is ruled out. This way a conversion of the components from the first position to the second position is possible by the compressive force that can be exerted by the user in the direction of travel of the vehicle.

This embodiment of the scooter or of the vehicle is advantageous because with it obstruction of the user by the component on leaving the scooter in a dangerous situation is excluded. This component can thereby be placed in a position under the compressive force acting on the part of the user (this is produced, i.a. by the marked retardation, e.g. during emergency braking or collision with obstacles), which position, although it is ineffective in terms of counteracting the tilting moment, makes it possible for the user to leave the scooter quickly.

With a vehicle or a machine with at least one drive pedal that forms a support surface for actuation by the user, it is preferably provided that at least one additional spring element is switched in the drive train chain between the support surface of the drive pedal and a drive wheel, which spring element determines the resilience of the support surface of the drive pedal with respect to the other components of the vehicle or of the machine.

This embodiment of the scooter or of the vehicle has the advantage that with an uneven road surface or upon running over obstacles the sudden high stresses that act from the scooter accelerated in the perpendicular direction on the drive mechanism and the user (via the drive pedal) are reduced. It is possible thereby to design the suspension and in particular the damped suspension of the scooter more simply in terms of technology than in the case of a separate suspension of each wheel.

This is achieved for example in that the spring element is embodied as an elastic mat that is integrated in the drive pedal. In an advantageously damped embodiment, oscillations of the vehicle caused by the spring element are suppressed.

Furthermore, it is preferable that a locking device that has one or more spring-mounted holders that are mechanically connected to at least one handle, can hold the drive pedal in the locked condition near its lower end position through the coupling with correspondingly shaped parts of the drive pedal and can be released with an external load of the drive pedal under the action of the spring.

The advantage of this solution lies in that the drive pedal under the action of the return spring cannot be placed in the first end position until the user has already started moving and the drive pedal is loaded under the muscular power, whereby an unlocking of the drive pedal takes place. This facilitates the start of each ride, because in the locked state the drive pedal projects only insignificantly over the road surface. Moreover, the use of the vehicle, in particular of a scooter, is possible if desired without use of the drive mechanism for instance in down hill run or when carrying luggage on the drive pedals.

### BRIEF DESCRIPTION OF THE DRAWING

The above and other objects, features, and advantages will become more readily apparent from the following description, reference being made to the accompanying drawing in which:

FIG. 1 is a kinematic diagram of a prior-art drive pedal with the support surface parallel to the road surface;

FIG. 2 is a kinematic diagram of a prior-art pivotal short drive pedal with a small vertical travel;

FIG. 3 is a kinematic diagram of a prior art pivotal long drive pedal with a large vertical travel;

FIG. 4 is a kinematic diagram of an inventive pivotal short drive pedal with a large vertical travel;

FIGS. 5A and 5B are a diagrammatic side and sectional top views of a scooter drive mechanism according to the invention;

FIG. 6 is a bottom view showing the mounting of the steerable wheel of the scooter according to the invention;

FIG. 7 illustrates a possible structure of the steering mechanism of the scooter with the supporting components for counteracting tilting;

FIG. 8 illustrates a possible structure of the steering mechanism of the scooter with pivots between the components and the steering column;

FIGS. 9A and 9b illustrate another possible structure of the steering mechanism of the scooter with pivots between the components and the steering column, the drive mechanism not shown for the sake of clarity; and

FIG. 10 is a side view of an embodiment of the scooter with locking of the drive pedal.

### SPECIFIC DESCRIPTION

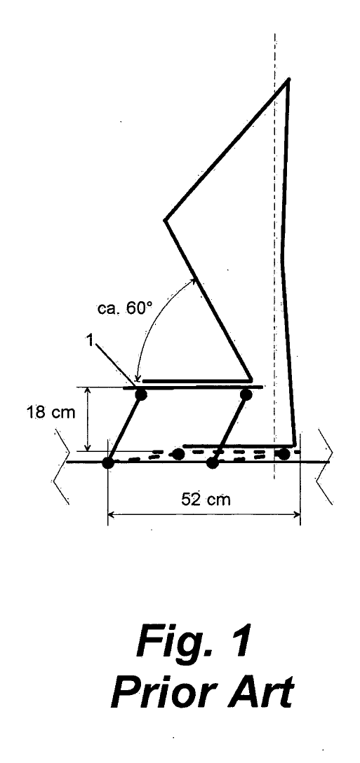

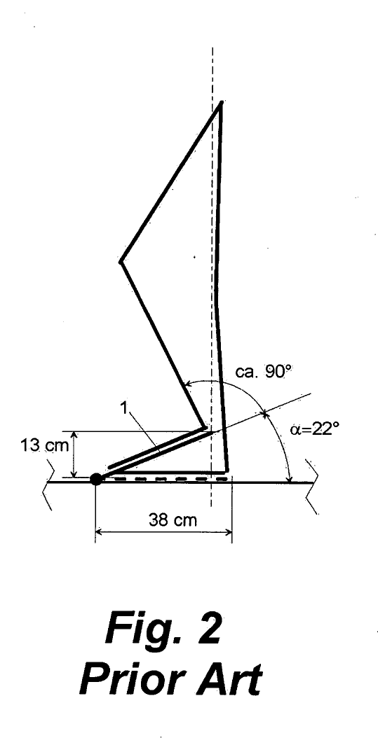

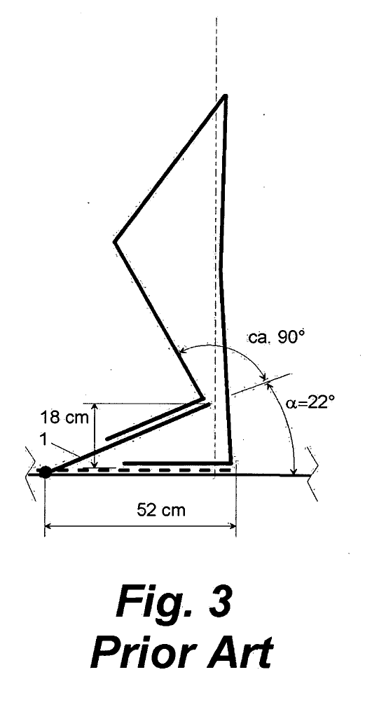

FIG. 1 shows the system from U.S. Pat. No. 4,846,488 where, as in FIGS. 2-4, the lengths of the elements are illustrated approximately to scale with the solid lines showing the positions of the elements in the upper end position and the dashed lines in the lower end position of the drive pedal. It comprises several levers or links connected together in a parallelogram, the pivots of which make it possible for the support surface of drive pedal 1 to be always parallel to the normally horizontal frame of the scooter. One disadvantage of this solution lies in that with a relatively large vertical travel of the drive pedal 1, it leads to a stress of the user's ankle joint that does not occur when the person walks and runs on a horizontal or slightly tilted plane. This stress is one of the fatigue factors for the user of the scooter and should therefore be avoided. The proportion of the length of the scooter utilized by the drive pedal 1 in this embodiment (and with the assumed size of the legs of the user and the diagrammatically shown arrangement of the components with the vertical travel 18 cm) is 52 cm. Although another known embodiment of the drive pedal 1 (DE 103 12 878 B4, U.S. Pat. No. 7,111,860) corresponds to the natural position of the leg, it requires for a relatively large vertical travel of 18 cm and a length of the drive pedal 1 of likewise 52 cm as shown in FIGS. 2 and 3.

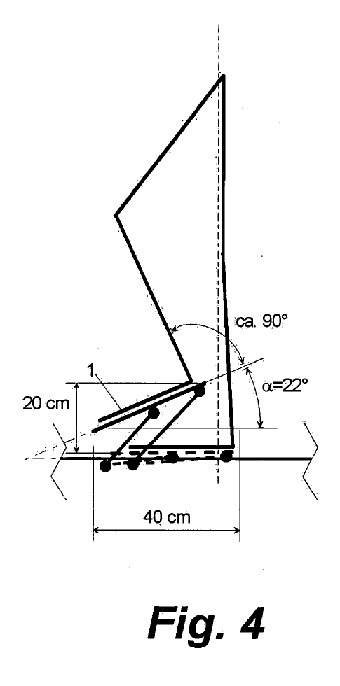

With the solution according to the invention as shown in FIG. 4, a vertical travel of 20 cm with a minimal length of 40 cm can be used. The concrete embodiment of the kinematic connection between the drive pedal 1 and the frame can be different. For example, two rear links can be mounted on both sides of the drive pedal 1, but only one front link need be provided in the center of the drive pedal 1. In the example under consideration there are two drive pedals 1 mounted symmetrically with respect to the center longitudinal axis of the scooter.

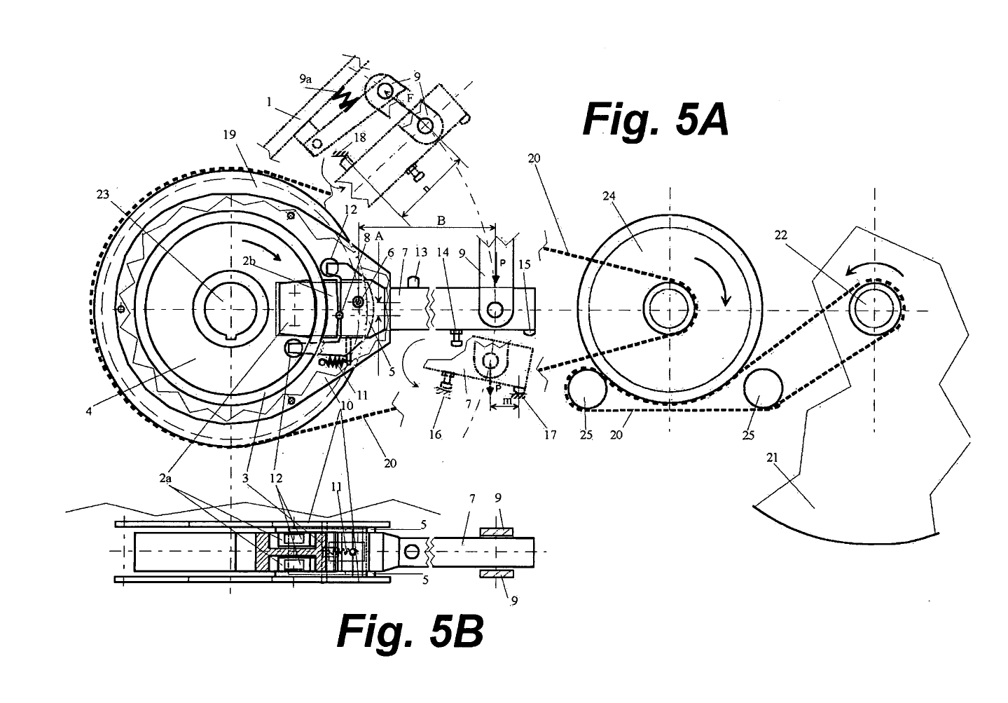

In FIGS. 5A and 5B front and rear (or inner and outer) drive shoes 2a and 2b can grip a cylindrical rim or wall 3 of an input wheel 4 of the drive mechanism. The inner drive shoe 2a is carried on a holder link plate 5 pivoted at 6 to a lever 7. In the example under consideration as best seen in FIG. 5B there are two hollow cylinders or rims 4 per drive pedal 1, which are separated from one another by central wall, and thus there are two shoes 2a on one link plate 5 of each drive pedal 1 that are symmetrical with respect to the central axis of the axle 23 of the hollow cylinder 4, so that the pivot 6 connects both link plates 5 to the lever 7. This way the cylinder rim 3 is chiefly symmetrically loaded with the compressive force, so that the entire locking device has a high bearing capacity with the relatively small dimensions and weight.

A second pivot 8 is provided between the lever 7 and the outer drive shoe 2b, which second pivot 8 is a pin or bolt lying in semicylindrical grooves of the parts 2b and 7 (between the link plates 5) and is offset angularly of the pivot 6. In other words the pivot axis 6 between the lever 7 and the support 5 is to one side of a radius from the axle 23 carrying the wheel 4 and the pivot 8 between the shoe 2b and the support 5 is to the other side of this radius. The pivot 8 is chiefly designed for the transmission of the compressive forces between the shoes 2a and 2b and from the shoe 2b to the lever 7. To secure the shoe 2b and prevent the pin of the pivot 8 from falling out (in the case of greater wear of the components) and to reduce friction between the shoes 2a and 2b and the rim on return or upward movement of the drive pedal 1, the shoe 2b can also be urged by small spring(s) (not shown in the drawing) radially inward. The lever 7 is pivoted on the lower end of a link 9 whose upper end is pivoted on the outer end of the drive pedal 1. The shoe 2b can convert the force transmitted by the drive pedal 1 through its pivot to the lever 7 into gripping action (radial outward movement of the shoe 2b and radial inward movement of the shoe 2a) of the shoes 2a and 2b on the rim 3 of the drive wheel 4. From the sides, the mechanical structure of the locking device formed by the two shoes 2a and 2b is held together by two annular plates 10 screwed to one another. A small tension spring 11 generates a torque that presses surfaces of the shoes 2a and 2b on the rim 4 in weak contact with a lack of external action of force. This contact is eliminated by the force F of a return spring (not shown in the drawing) carried on the drive pedal 1, which return spring is much stronger than the spring 11.

Back-up rollers 12 are carried on the lever 7, on which rollers 12 the lever 7 on the upward return stroke of the drive pedal 1 after an operation together with the parts 2a, 2b, 5, 6, 8-11, can be guided in a low-friction manner. Bumpers 13 and 15 on the lever 7 and respective abutments 16 and 18 on the frame define the upper and lower end positions of the drive pedal 1 and make it possible for the pedal 1 to stop and change directions gently and quietly at the beginning and at the end of each operation of the drive pedal 1. In these end positions of the drive pedal 1 contact is made between the respective bumpers 13 and 15 and the abutments 16 and 18, a torque Pm (lower end position) and Fn (upper end position) acting on the lever 7 and the axes of the back-up rollers 12 attached to it. A reversal of the drive mechanism is thus effected. At least one of the supports (in the example shown, the support 14) is formed as a screw with which the adjustment of the lever can be set upon switching off the torque transmission in the lower end position of the locking device. This means that in the lower end position of the drive pedal 1 the grip of the shoes 2a and 2b on the rim 3 of the wheel 4 is interrupted while there is still no contact of the latter with the back-up rollers 12. Consequently, switching of the drive mechanism in the lower end position is virtually silent, although it takes place under the weight of the user. Preferable the abutments, and/or bumpers are made of an elastic material (plastic, rubber) for the purpose of further reducing noise or the overloading of the components (e.g., with the return of the drive pedal 1 without counteracting by the user in the case of leaving the scooter).

The input wheel 4 carries a toothed pulley or sprocket 19 is connected via a chain or toothed belt 20 to a step-up wheel 24 whose outer periphery engages another chain or toothed belt 20 spanned over guide wheels 25 and engaging a sprocket or toothed wheel 22 carried on a driven rear wheel 21 of the scooter so as to rotate it in a direction opposite that of the wheel 4.

A damper spring 9a can be provided in the force transmission chain between the drive pedal 1 and the drive wheel 21, with which spring element the stresses of the components with an uneven road surface can be reduced and riding comfort can be increased. A more cost-effective and weight-reducing solution lies in the arrangement of an elastic mat (e.g., of a layer of cellular rubber between two layers of a harder plastic) on the support surface of the drive pedal 1.

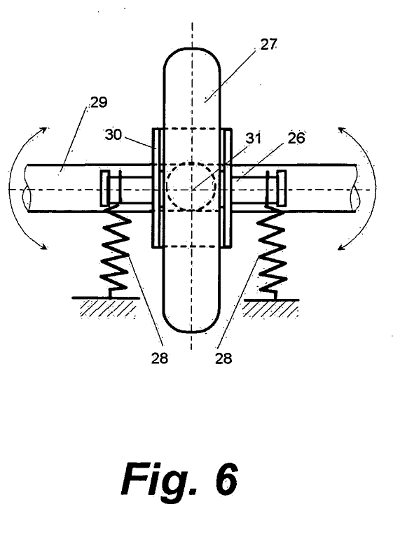

As shown in FIG. 6, longitudinally extending coil springs 28 connected between an axle 26 of a steerable front wheel 27 and the scooter frame are set by an unillustrated adjusting screw or the like such that with no actuation of the steering arm 29 the wheel 27 is located in a central position that corresponds to a straight-ahead motion, that is parallel to the longitudinal axis of the scooter frame. The torque generated by the springs 28 is used to avoid an unnecessary reaction by the user to the tilting moment in the form of the change in the direction of travel by actuation of the link in a work cycle of the drive pedal 1. This reaction would cause a periodic deviation of the scooter from the straight-ahead travel and is therefore disadvantageous. For the necessary stabilizing effect of the torque generated by the springs 28, its value should be sufficiently large, but without impairing steering of the scooter due to the excessively large torque during the desired changes in the travel direction, that is when turning the wheel 27 to steer the scooter. To this end the weakest possible increase in the torque with the increase of the steering-lock angle is desired, in particular in the usual range of the steering of about ±45°. The connection of the springs 28 shown in the drawing makes it possible that as the steering deflection increases, the torque applied by the springs 28 increases more weakly than linearly and not in a disproportionate manner as with known solutions as in US 2007/0182123. The described relationships mean that on turning the wheel 27 the resisting torque the torque is not rising and thereafter does not increase positively.

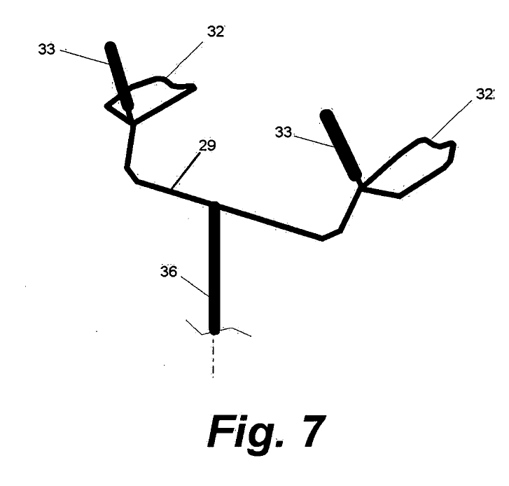

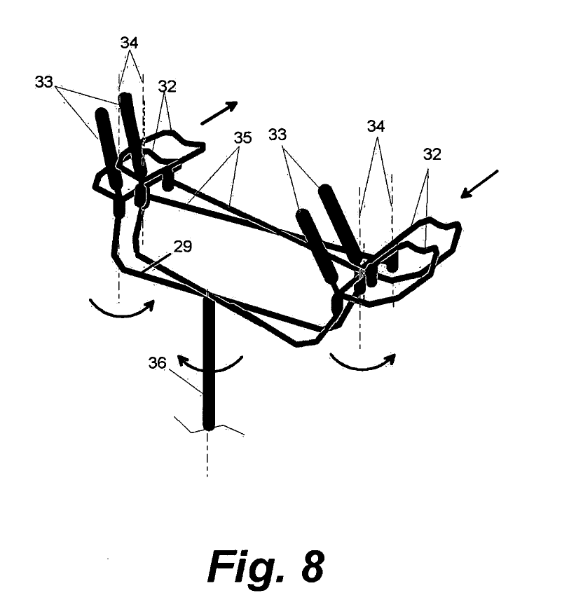

As shown in FIGS. 7 and 8, for the compensating out the tilting moment on actuation of the drive pedal 1, two loops 32 are formed on the ends of steering 29, which loops are located next to handles 33 and serve as support surfaces for the arms of the user (preferably during straight-ahead travel). This solution can be expanded by a connection between the support surfaces 32 and the actual link 29, so that the support is also possible when turning (FIG. 8, the position of the structure shown in gray corresponds to turning). The positions of the hinged axes 34 or the other components of the scooter correspond to the most comfortable possible steering and should be adjustable. Both support surfaces 32 can be connected to one another by a link 35 so that the rotation of the support surfaces 32 is synchronized during the change of the travel direction. Another advantage of this embodiment lies in the mechanical stability and the maintenance of the form in the collapsed state of the scooter.

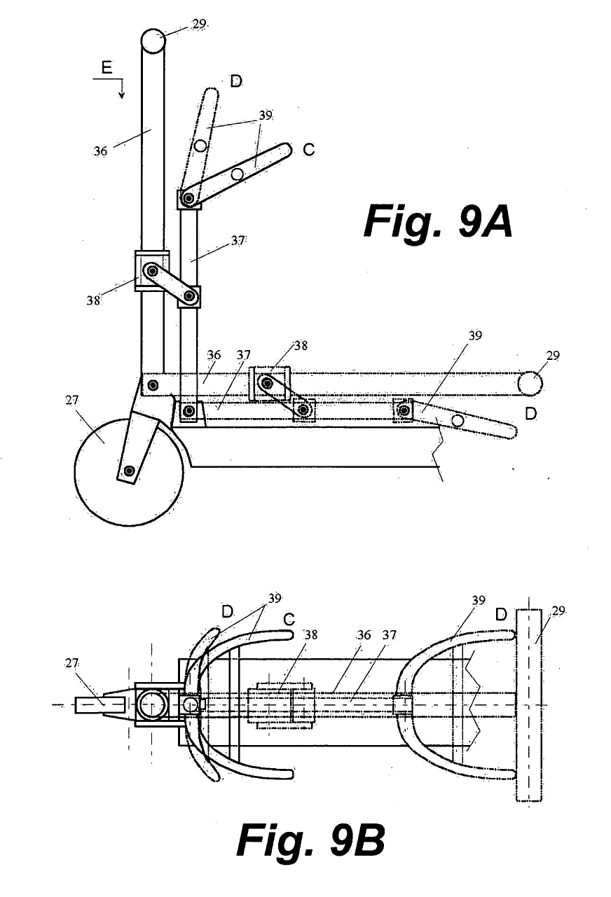

FIGS. 9A and 9B show another embodiment intended to counteract tilting when pedaling. Here the scooter has an additional column 37 that is arranged parallel to the steering column 36 connecting the steering arm 29 axle 26 and is pivoted on the frame of the scooter so that it can be collapsed together with the steering column 36 in the longitudinal direction of the scooter, but does not have any other degree of freedom with respect to the frame. The column 37 is connected via two links to a bearing 38 (e.g., a bushing of plastic) installed on the steering column 36 and secured against axial displacement thereon, which renders possible the above-referenced collapsing of both columns 36, 37 and the unhindered rotation of the steering column 36 with the steering of the scooter. A yoke 39 is installed at the upper end of the column 37 that can assume two stable positions C and D by a spring-mounted flexible connection to the column 37: one tilted toward the rear and one approximately perpendicular position. Shifting of the yoke 39 from the first into the second position can be carried out under the action of the compressive force exerted on the yoke 39 by the user with intensive braking or collision with an obstacle. It is thus possible for the user to leave the scooter unimpeded in a critical situation. In the first of the above-referenced positions, the tilting moment developing during the ride is transmitted to the body of the user via the yoke 39 and the lateral fluctuations of the spatial position of the scooter are reduced or eliminated.

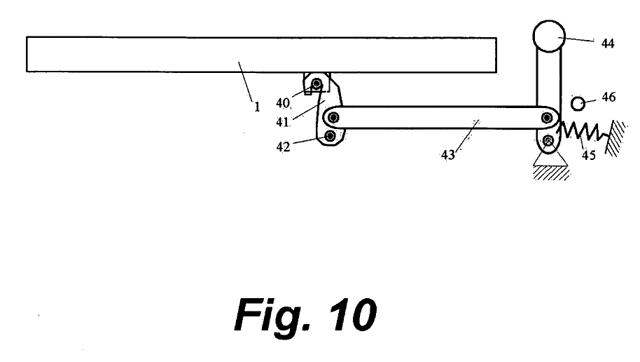

As shown in FIG. 10, each of the two drive pedals 1 is provided with a pin 40 that can be held by a respective laterally arranged hook 41 slightly above the lower end position of the drive pedals 1. The hooks 41 are pivoted at 42 and connected via respective links 43 to a pivot handle 44. Front upper edges of the hooks 41 have oblique or rounded profiles so that they can be rotated backward slightly in the lowermost end position of the respective pedals 1. If both of the drive pedals 1 are not held (locked) by the hooks 41, the latter and the handle 44 are positioned by springs 45 in rear end position defined by a limit stop at a limiter 46, permitting free vertical movement of the respective pedals 1. A handle can possibly also be arranged on the steering column with a mechanical connection with the hooks 41 via a Bowden cable.

The scooter functions in the following manner. After pushing down both of the drive pedals 1 previously locked by the user, they are automatically released and brought into the upper end position with sufficient reduction of the compressive force under the action of the respective return spring. On subsequent actuation of one or both of the drive pedals 1 by the user, the lever 7 is rotated about the axis of the pivot 6 in a clockwise direction, so that the shoes 2a and 2b grip the rims 3 of the wheel 4. This takes place through the transmission of force between the lever 7, the pivots 6, 8, the shoe 2b, the link plates 5 and the shoes 2a. On rotation of the lever 7 about the axis of the pivot 6, the backup rollers 12 are moved away from the rim 3 (preferably by about 1-2 mm). Further actuation of the drive pedal 1 by the user leads to the rotation of the parts 2, 4, 19, i.a. about the axis of the drive shaft 23 in the direction of the transmission of the drive torque to the drive wheel 21 of the scooter. The same applies in the case of the actuation of the drive pedal 1 before its upper end position is reached after a return. After the lower end position of the drive pedal 1 (of the lever 7) has been reached, this transmission is interrupted by the action of the switchover mechanism (supports 14-17) to trip up the lever 7, thereby unclamping the rims 3 from between the shoes 2a and 2b and engaging the rollers 12 on the inner and outer surfaces of the rim 3, and the scooter moves forward with relative rotation of all the drive parts relative to the grip shoes 2a and 2b and the lever 7 carrying them. The same occurs with an interruption of the actuation of the drive pedal 1 by the user in an intermediate position and the change of the direction of movement of the drive pedal 1 before the lower end position has been reached, but without involvement of the supports 14-17. In the lower end position of the drive pedal 1, the support rollers 12 of the locking device do not come into contact with the rim 3 of the wheel 4 until the drive pedal 1 has been freed from the action of the weight of the user and a return of the drive pedal 1 thus begins.

The tilting moment developing during this operation is compensated through the support of the arms of the user on the link 29 at the support surfaces 32 or through contact of the yoke 39 with the body of the user, which results in a reduction of the negative influence on driving stability. If the road surface does not have any major unevennesses and no acceleration of the drive pedal 1 in the perpendicular direction takes place, the connecting rod 9 with the spring element 9a or the elastic mat on the (or in the) drive pedal 1 acts like a rigid mechanical unit. If unevennesses occur or if for another reason a perpendicular acceleration of the drive pedal 1 occurs, the accelerating force acts on the spring element 9a. Through this action the acceleration of the user and the strain developing in the “scooter user” mechanical system is reduced. After relief of pressure on the drive pedal 1, the tensioned elastic element 9a returns relatively slowly due to the damping that may be present, so that no vibration of the drive pedal 1 occurs that is unpleasant to the user.

With the reduction of the muscular force of the user acting on the drive pedal 1, the drive pedal 1 moves upward under the action of the return spring. In the upper end position the upper supports 13, 18 act on the lever 7 so that the torque transmission through the locking device in both directions is also interrupted in the upper end position of the drive pedal 1.

By interrupting the torque transmission in both end positions of the drive pedal 1, movement of the scooter backward on its wheels is possible (without blocking the drive mechanism as is the case with conventional freewheel mechanisms). For this reason the scooter can be used without having to lift it around obstacles or in turns (this is inconvenient with a vehicle with a frame arranged only a few centimeters above the road surface) and without the use of a special switching device, such as was provided, for example, in U.S. Pat. No. 7,111,860. Apart from the improvement of the handling, this solution prevents an overload of the drive mechanism with a forced pulling or pushing of the scooter backward on the wheels. This danger can be substantial as a result of the necessary very small gear ratio (approx. 0.04-0.05) of the drive to the wheels.

After the end of a ride, the scooter is held by the user standing on the ground with one hand on the steering column 36 and with the other hand on the handle 44 such that the rear wheel is slightly lifted from the road surface and can rotate freely. Both drive pedals 1 are brought into the lower end position by the user by pushing with the foot. With this approach, the hooks 41 are pushed forward by the handle 44 pulled upward virtually perpendicular via the link plates 43 around the axes 42. When a sliding contact is produced between the upper front profiles of the hooks 41 and the pins 40, the hooks 41 are pressed backward by the pins 40 against the weak (due to the transmission) force transmitted by the handle 44 via the link plates 43, and with further movement of the drive pedals engage downward in the pins 40. With the subsequent release of the drive pedals 1 and subsequently of the handle 44, the drive pedals 1 urged upward by the return spring remain in the locked state in the vicinity of the lower end position until they are both pushed down again from above. However, the loading of only one of the drive pedals 1 does not result in the unlocking of any of the drive pedals 1, due to the coupling of the hooks 41 via the link plates 43 and the handle 44, so that the use of the scooter without application of the drive mechanism is possible. Of course, the pins 40 can be arranged on the levers 7 instead of the drive pedals 1 or the hooks 41 can be exchanged with the pins 40.

With a muscle-powered vehicle, the propelling power of which is produced by a step-like movement by the user's legs, an uphill movement is useful in energy terms when this movement renders possible an increase in speed within the scope of the power developed by the user that is higher than his walking speed would be under the same conditions (gradient, etc.). If this is not the case, it is more favorable for the user from the point of view of power requirements to get off the vehicle and to walk pushing the vehicle instead of riding it. The reason is among other things that with any vehicle with drive mechanism a part of the power is lost by unavoidable losses (friction in the drive mechanism, overcoming the spring force, i.a.). With the assumption that the power of an average rider developed in a sustained manner is approx. 150 W, for the “lower limiting velocity” of 1.5 m/s (5.4 km/h), the maximum gradient that can be overcome in energy terms while riding is approx. 12% (approx. 7°). If the scooter is not equipped with switchable gears (for example, hub gears of a bicycle) (this equipment can definitely be useful), with the design of the drive mechanism a “golden mean” should be found between the maximum achievable speed and the maximum producible propelling power (this is, the gradient that can still be overcome at constant speed). Based on the above considerations regarding the maximum gradient, it seems expedient to select the transmission of the drive mechanism such that the maximum propelling power reaches approx. 60-70 N and the maximum speed on a horizontal plane reaches approx. 18-20 km/h (for safety reasons and in terms of forward movement this speed is definitely sufficient for a relatively small vehicle).

With a vertical travel of the drive pedals 1 of 20 cm, a user mass of 80 kg and a moderate actuation frequency of the drive pedals 1 of 1 s⁻¹, the average gross power with uphill travel with the constructed prototype of the scooter at a constant speed of approx. 2.5 m/s (9 km/h) on a plane titled by 3° is approx. 140 W. In the case of a bicycle, this power could be achieved in sustained operation only by a very fit user (unless the bicyclist separates himself from the saddle and thus changes the bicycle into a “scooter”). The overall length of the scooter with 8″ wheels is less than 90 cm, the height and width with the collapsed steering column 36 are approx. 30 cm, it is therefore possible to taken even several scooters in any car without a special roof rack.

The example described represents only part of the possible embodiments of the scooter. Others solutions that can be implemented with known means can be realized on the basis of the solutions considered above.

We claim:

1. A muscle-powered machine comprising:
a frame;
a drive wheel rotatably mounted on the frame and rotatable in a plane defining a normal straight-ahead travel direction;
a drive pedal engageable with a foot of a user of the machine and having one end pivoted on the frame forward of the user's foot, the pedal being pivotal through an acute angle on the frame between an upper position and a lower position with the pedal extending at an angle of 90° ±10° to a lower leg of the foot on the pedal, a quotient of the maximum vertical travel of the pedal measured perpendicular to the pedal in its lower end position and the sine of the angle is greater than the length of the pedal measured radially of its pivot; and
drive means connected between the pedal and the drive wheel for converting oscillation of the pedal between its end positions into rotation of the wheel.

2. The machine defined in claim 1 wherein the angle is 25°.

3. The machine defined in claim 1, further comprising at least two links of different lengths and having lower ends pivoted on the frame and upper ends pivoted on the lever, the links, frame.

4. The machine defined in claim 3 wherein the link closer to the pivot of the lever is shorter than the other link.

5. The machine defined in claim 1 wherein the vehicle is a scooter and further includes;
a steerable wheel spaced longitudinally from the drive wheel.

6. The machine defined in claim 5 wherein the drive means includes:
an input wheel rotationally coupled to the drive wheel;
a shoe assembly engageable with the input wheel to couple the pedal to the input wheel; and
a spring urging the shoe assembly into engagement with the wheel only on displacement of the pedal from the upper to the lower position.

7. The machine defined in claim 6 wherein the input wheel is centered on an axis and has a coaxial rim, the shoe assembly comprising a pair of shoes radially flanking the rim and shiftable by the spring radially into engagement with the rim on movement of the pedal from the upper position to the lower position.

8. The machine defined in claim 7 wherein the locking means includes
a lever defining respective pivot points at which the shoes are pivoted and that are spaced apart by a predetermined distance another pivot spaced from the pivot points by a distance equal to much more than the spacing between the pivot points.

9. The machine defined in claim 8 wherein the rim has inner and outer surfaces centered on the input-wheel axis and the inner and outer shoes have faces complementarily arcuate to the respective inner and outer surfaces.

10. The machine defined in claim 9 wherein the drive mechanism includes a toothed-belt or chain drive connected between the input wheel and the drive wheel.

11. The machine defined in claim 10 wherein the input wheel has two such rims and there are two such pedals each coupled via respective such shoe assembly to a respective one of the rims.

12. The machine defined in claim 5, further comprising
a pair of springs flanking the steerable wheel and operatively engaged between same and the frame and loaded such that the steerable wheel is urged with a predetermined angular force into a position parallel to the drive wheel.

13. The machine defined in claim 5 wherein there are two such pedals laterally flanking a longitudinal axis of the scooter and the machine further comprises:
at least one support fixed to the frame, spaced above the wheels, and braceable against a body of the user of the scooter to counteract a tilting effect caused by pushing down on one or the other of the pedals.

14. The machine defined in claim 13, further comprising
a steering element on journaled about an upright axis in the frame and having a lower portion on which the steerable wheel is journaled and an upper portion graspable by the user of the scooter and also forming the support.

15. The machine defined in claim 13 wherein the support is spring-biased into a use position engaging the user of the scooter and can be pivoted from the use position against spring force into an out-of-the-way position permitting the user to dismount from the scooter.

16. The machine defined in claim 1, further comprising
a spring element engaged between the drive pedal and the drive means for limited relative movement of the drive pedal and drive means.

17. The machine defined in claim 16 wherein the spring element is an elastic mate integrated into the drive pedal.

18. The machine defined in claim 16 wherein the spring element is damped.

19. The machine defined in claim 1, further comprising
releasable means for securing the pedal in the lower position.

20. The machine defined in claim 19 wherein the releasable means includes a hook displaceable into a position engaging and holding down the pedal.
